(19) United States
(12) Patent Application Publication
(10) Pub. No.: US 2007/0201656 A1
(43) Pub. Date: Aug. 30, 2007

(54) Time-scaling an audio signal

(75) Inventors: Ari Lakaniemi, Helsinki (FI); Pasi Ojala, Kirkkonummi (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/350,257

(22) Filed: Feb. 7, 2006

(51) Int. Cl. H04M 3/42

(52) U.S. Cl. 379/201.01

(57) ABSTRACT

For time-scaling an audio signal, which is distributed to a sequence of frames, one scaling period is removed from the audio signal within a current frame, in case the audio signal is to be shortened in the time-scaling. Moreover, a segment of the audio signal following upon the removed scaling period is modified, for concealing said removal of a scaling period, at least partly in a subsequent frame, in case a segment of the audio signal following upon the removed scaling period within the current frame is shorter than desired for the modification.

### FIELD OF THE INVENTION

The invention relates to a method for time-scaling an audio signal. The invention relates equally to a chipset, to an audio receiver, to an electronic device and to a system enabling a time-scaling of an audio signal. The invention relates further to a software program product storing a software code for time-scaling an audio signal.

### BACKGROUND OF THE INVENTION

Time-scaling an audio signal may be enabled for example in an audio receiver that is suited to receive encoded audio signals in packets via a packet switched network, such as the Internet, to decode the encoded audio signals and to playback the decoded audio signal to a user.

The nature of packet switched communications typically introduces variations to the transmission times of the packets, known as jitter, which is seen by the receiver as packets arriving at irregular intervals. In addition to packet loss conditions, network jitter is a major hurdle especially for conversational speech services that are provided by means of packet switched networks.

More specifically, an audio playback component of an audio receiver operating in real-time requires a constant input to maintain a good sound quality. Even short interruptions should be prevented. Thus, if some packets comprising audio frames arrive only after the audio frames are needed for decoding and further processing, those packets and the included audio frames are considered as lost. The audio decoder will perform error concealment to compensate for the audio signal carried in the lost frames. Obviously, extensive error concealment will reduce the sound quality as well, though.

Typically, a jitter buffer is therefore utilized to hide the irregular packet arrival times and to provide a continuous input to the decoder and a subsequent audio playback component. The jitter buffer stores to this end incoming audio frames for a predetermined amount of time. This time may be specified for instance upon reception of the first packet of a packet stream. A jitter buffer introduces, however, an additional delay component, since the received packets are stored before further processing. This increases the end-to-end delay. A jitter buffer can be characterized by the average buffering delay and the resulting proportion of delayed frames among all received frames.

A jitter buffer using a fixed delay is inevitably a compromise between a low end-to-end delay and a low number of delayed frames, and finding an optimal trade off is not an easy task. Although there can be special environments and applications where the amount of expected jitter can be estimated to remain within predetermined limits, in general the jitter can vary from zero to hundreds of milliseconds—even within the same session. Using a fixed delay that is set to a sufficiently large value to cover the jitter according to an expected worst case scenario would keep the number of delayed frames in control, but at the same time there is a risk of introducing an end-to-end delay that is too long to enable a natural conversation. Therefore, applying a fixed buffering is not the optimal choice in most audio transmission applications operating over a packet switched network.

An adaptive jitter buffer can be used for dynamically controlling the balance between a sufficiently short delay and a sufficiently low number of delayed frames. In this approach, the incoming packet stream is monitored constantly, and the buffering delay is adjusted according to observed changes in the delay behavior of the incoming packet stream. In case the transmission delay seems to increase or the jitter is getting worse, the buffering delay is increased to meet the network conditions. In an opposite situation, the buffering delay can be reduced, and hence, the overall end-to-end delay is minimized.

Since the audio playback component needs a regular input, the buffer adjustment is not completely straightforward, though. A problem arises from the fact that if the buffering delay is reduced, the audio signal that is provided to the playback component needs to be shortened to compensate for the shortened buffering delay, and on the other hand, if the buffering delay is increased, the audio signal has to be lengthened to compensate for the increased buffering delay.

For Voice over IP (VoIP) applications, it is known to modify the signal in case of an increasing or decreasing buffer delay by discarding or repeating a part of the comfort noise signal between periods of active speech when discontinuous transmission (DTX) is enabled. However, such an approach is not always possible. For example, the DTX functionality might not be employed, or the DTX might not switch to a comfort noise due to challenging background noise conditions, such as an interfering talker in the background.

In a more advanced solution taking care of a changing buffer delay, a signal time scaling is employed to change the length of the output audio frames that are forwarded to the playback component. The signal time scaling can be realized either inside the decoder or in a post-processing unit after the decoder. In this approach, the frames in the jitter buffer are read more frequently by the decoder when decreasing the delay than during normal operation, while an increasing delay slows down the frame output rate from the jitter buffer.

In an audio receiver that is equipped with an adaptive jitter buffer and a time scaling functionality, the network status and the buffer status are monitored constantly. Based on the status of the buffer and the network, time scale modifications are performed on an audio signal, either by adding or by removing segment(s) of the audio signal, to compensate for any change in the buffer delay.

The challenge in performing time scale modifications in active parts of the audio signal is to keep the perceived audio quality at a sufficiently high level. A time scale modification that requires a relatively low complexity for maintaining a good voice quality can be realized for example with pitch-synchronous mechanisms. In a pitch-synchronous time-scaling, full pitch cycles are repeated or removed to create a scaled signal of a required length.

The principle of a pitch-synchronous time-scaling is illustrated in FIG. 1, which presents three curves from top to bottom. The uppermost curve represents the amplitude of an original speech signal over time. The amplitude may have any value of a 16-bit signed integer. It comprises a sequence of similar waveforms, which are referred to as pitch cycles. One of the pitch cycles represented in bold lines is selected for scaling. The curve in the middle of FIG. 1 represents the amplitude of the audio signal after having been stretched by repeating the selected pitch cycle once. The segment of the signal represented by dotted bold lines, which follows immediately upon the selected pitch cycle, is the repeated pitch cycle. The curve at the bottom of FIG. 1 represents the amplitude of the audio signal after having been shortened by removing the pitch cycle represented by bold lines in the audio signal of the uppermost curve of FIG. 1.

In the case of strongly voiced signals, the length of the pitch cycle, referred to as pitch period, remains constant over a relatively long period of time, even in the order of hundreds of milliseconds. However, even in these cases, the waveform of the signal slowly evolves. Therefore, a good-quality time scale modification requires in addition some kind of smoothing to ensure good sound quality around the point of discontinuity created by the repeated or removed piece of signal. A simple but well-working method to do this is to ‘cross fade’ the signals in the repeated or removed pitch period and the following pitch period. An example for a pitch-synchronous time-scaling using such a smoothing is the Pitch Synchronous Overlap-Add (PSOLA) technique.

In many platforms and audio processing architectures, it is further beneficial to apply the time-scaling processing on a frame by frame basis. For example, with Adaptive MultiRate (AMR) and all other Global System for Mobile Communications (GSM) codecs, this means that the time-scaling unit always processes 20 ms input blocks.

A time-scaling unit receiving audio frames and employing ‘cross-fading’ may compute an output frame including an added pitch cycle for instance according to the following set of equations:
sₒᵤₜ(k,i)=sᵢₙ(k,i), i=1 . . . p
sₒᵤₜ(k,i)=w₁(i−p)*sᵢₙ(k,i−T₀)+w₂(i−p)*sᵢₙ(k,i), i=p+1 . . . p+T₀
sₒᵤₜ(k,i)=sᵢₙ(i−T₀), i=p+T₀+1 . . . N+T₀ (1)
where sᵢₙ(k, i) denotes sample i of input frame k, sₒᵤₜ(k, i) denotes sample i of output frame k, N is the input frame length in samples, p is a selected insertion point, T₀ is the pitch period in samples, and w₁ and w₂ are weighting functions fulfilling w₁(i)+w₂(i)=1. By way of example, the weighting functions can be defined as:
w₁(i)=i/T₀
w₂(i)=1−i/T₀

The set of equations (1) provides a smooth transition between the pitch period of length T₀ preceding the insertion point p and the pitch period of length T₀ following the insertion point p.

The impact of the set of equations (1) is also illustrated in FIG. 2. FIG. 2 presents an input frame k of length N, for which a pitch period T₀ preceding a selected insertion point p and a pitch period T₀ following upon this insertion point p are highlighted. FIG. 2 further presents a generated output frame k of length N+T₀, in which an additional pitch cycle of length T₀ has been inserted at insertion point p. The inserted pitch cycle is computed as a weighted sum of the pitch cycles around insertion point p in input frame k.

It has to be noted that this processing requires the pitch cycle following upon the insertion point p, i.e. the samples from sᵢₙ(k, p+1) to sᵢₙ(k, p+T₀), to be available in the current input frame k. The samples in the subsequent input frame k+1 cannot be exploited, since that frame k+1 cannot be assumed to be available. Further, it has to be noted that especially with large values of T₀, the term sᵢₙ(k, i−T₀) could have a negative sample index, indicating that samples from frame k−1 are needed as well for smoothing the signal. This implies that at least the T₀ most recent samples of input frame k−1 need to be kept in a memory to ensure all required data to be available also with low values of p. However, if the time scaling is applied inside the decoder by processing the received excitation signal, in many speech codecs, e.g. in AMR, the piece of excitation signal from the input frame k−1 that might be required in the set of equations (1) is readily available in the adaptive codebook memory without additional memory requirement.

The time-scaling unit may compute in a similar manner an output frame in which one pitch period has been removed. A output frame including a smooth transition from the pitch period preceding the pitch cycle that is to be removed to the pitch cycle following the dropped pitch cycle can be determined for example according to the following set of equations:
sₒᵤₜ(k,i)=sᵢₙ(k,i), i=1 . . . p−n₁
sₒᵤₜ(k,i)=w₁(i−p+n₁)*sᵢₙ(k,i)+w₂(i−p+n₁)*sᵢₙ(k,i+T₀), i=p−n₁+1 . . . p+n₂
sₒᵤₜ(k,i)=sᵢₙ(k,i+T₀), i=p+n₂+1 . . . N−T₀ (2)

In this set of equations, p is a selected modification point, n₁ is the number of samples preceding the removed pitch cycle that are to be smoothed, and n₂ is the number of samples following the removed pitch cycle that are to be smoothed. Generally, larger values for n₁ and n₂ imply a smoother transition and thereby a better voice quality. However, selecting n₁+n₂>T₀ is not expected to provide any advantage in terms of audio quality. Further, sᵢₙ(k, i), sₒᵤₜ(k, i), N, T₀, w₁ and w₂ have the same meaning as in the set of equations (1). Here, suitable weighting functions w₁ and w₂ could be for example:
w₁(i)=1−i/(n₁+n₂)
w₂(i)=i/(n₁+n₂)

The impact of the set of equations (2) is also illustrated in FIG. 3. FIG. 3 presents an input frame k of length N, for which a number of samples n₁ preceding a selected modification point p, a pitch period T₀ following upon modification point p up to point q=p+T₀, and a number of samples n₂ following upon this point q are indicated. FIG. 3 further presents a generated output frame k of length N−T₀, in which samples from modification point p to point q have been removed. The n₁ samples preceding modification point p and the n₂ succeeding modification point p in the output frame have been smoothed.

Extending the signal according to the set of equations (1) does not provide problems even with T₀ values close to frame size N, since exploiting the signal from the previous frame can be assumed to provide a working solution. Shortening the signal according to the set of equations (2), in contrast, can be problematic in some situations.

For example, if the optimal modification point p is too close to the beginning of the input frame, i.e. p<n₁, a part of the n₁ samples preceding the removed pitch period that are to be smoothed is already given to the decoder output in the previous frame. Thus, they cannot be changed any more. This is illustrated in the upper part of FIG. 4. The upper part of FIG. 4 is a diagram of a frame, in which p is smaller than n₁.

Moreover, if the modification point p is too close to the end of the input frame, i.e. (N−p−T₀)<n₂, a part of the n₂ samples following upon the removed pitch period that are to be smoothed is in the next input frame. Therefore, the smoothing according to the set of equations (2) cannot be completed. This is illustrated in the lower part of FIG. 4. The lower part of FIG. 4 is a diagram of a frame, in which (N−p−T₀) is smaller than n₂.

The AMR codec, for instance, uses N=160 samples (20 ms) per frame, while many male speakers introduce a pitch period above 80 samples (10 ms) for voiced speech, the maximum pitch period in AMR being 142 samples. Removal and smoothing of such a pitch period is not always possible using the set of equations (2) with desired values for n₁ and n₂. A known mechanism to take care of this problem is to truncate the smoothing window to cover only the part of the signal following the modification point p that is included in the current frame. That is, n₂ is set to N−T₀−p. While this gives sufficient performance in many cases, the quality may be degraded if the selected optimal modification point is close to the end of the frame and/or if the pitch cycle that is removed is long.

### SUMMARY OF THE INVENTION

It is an object of the invention to improve the smoothing in a time-scaling operation applied to an audio signal. It is in particular an object of the invention to improve the smoothing for the case that the audio signal is to be shortened in a time-scaling operation.

A method for time-scaling an audio signal is proposed. The audio signal is distributed to a sequence of frames.

In case the audio signal is to be shortened in the time-scaling, the method comprises removing one scaling period from the audio signal within a current frame. The method further comprises modifying a segment of the audio signal following upon the removed scaling period, for concealing the removal of a scaling period, at least partly in a subsequent frame, in case a segment of the audio signal following upon the removed scaling period within the current frame is shorter than desired for the modification.

Moreover, a chipset with at least one chip for time-scaling an audio signal is proposed. The audio signal is assumed to be distributed to a sequence of frames. The at least one chip comprises a frame shortening component, which is adapted to remove one scaling period from an audio signal within a current frame, in case the audio signal is to be shortened in a time-scaling. The frame shortening component is further adapted to modify a segment of an audio signal following upon a removed scaling period, for concealing the removal of a scaling period, at least partly in a subsequent frame, in case a segment of the audio signal following upon the removed scaling period within the current frame is shorter than desired for the modification.

Moreover, an audio receiver comprising a time scaling unit for time-scaling an audio signal is proposed. The audio signal is assumed again to be distributed to a sequence of frames. The time scaling unit comprises a frame shortening component, which is adapted to realize corresponding functions as the frame shortening component of the proposed chipset. It has to be noted, however, that the time scaling unit can be realized by hardware and/or software. The time scaling unit may be implemented for instance in a chipset, or it may be realized by a processor executing corresponding software program code components.

Moreover, an electronic device comprising a time scaling unit for time-scaling an audio signal is proposed. The audio signal is assumed again to be distributed to a sequence of frames. The time scaling unit of the proposed electronic device comprises the same components as the time scaling unit of the proposed audio receiver. The electronic device could be for example a pure audio processing device, or a more comprehensive device, like a mobile terminal or a media gateway, etc.

Moreover, a system is proposed, which comprises a transmission network adapted to transmit audio signals, a transmitter adapted to provide audio signals for transmission via the transmission network and a receiver adapted to receive audio signals via the transmission network. The receiver corresponds to the above proposed audio receiver.

Finally, a software program product is proposed, in which a software code for time-scaling an audio signal is stored in a readable medium. The audio signal is assumed again to be distributed to a sequence of frames. When being executed by a processor, the software code realizes the proposed method. The software program product can be for example a separate memory device, a memory that is to be implemented in an audio receiver, etc.

The invention is based on the idea that the smoothing process of a time-scaling operation can be split up between a current frame and the next frame. The smoothing in a time-scaling operation, which removes a scaling period from a current frame, is more specifically a signal modification that is used for concealing the removal of this scaling period. It is proposed that such a modification is split up between a current frame and the next frame, whenever the signal segment following upon the scaling period within the current frame does not have a satisfactory length for a smoothing only within the current frame.

It is an advantage of the invention that the smoothing of the time scaled audio signal is ensured even over frame boundaries. This reduces the negative impact of the time scaling operation on the audio quality.

The scaling period may correspond to a pitch period. It has to be noted, however, that the scaling period may also have any other length, in particular an integer multiple of a pitch period or any length that is shorter than the pitch period. The scaling period may be selected taking into account the content of a respective frame. For example, for voiced signals, which have a clear periodic structure, it might be of advantage to use only integer multiples of the pitch period as scaling periods. For unvoiced signals, which do not have a periodic structure, in contrast, basically any scaling length can be used. In case the scaling shortens the signal, the total modification period has advantageously the length of one pitch period, even though other modification periods are possible as well.

The modification in the current frame can be performed exclusively based on an overlap-adding of signal segments in the current frame, while the modification in the subsequent frame can be performed based on an overlap-adding of signal segments in the current frame and signal segments in the subsequent frame.

An overlap-adding of signal segments could include for instance a weighting of the signal segments with a weighting function. If a weighting function is used, it could be for instance a simple triangular weighting function, but a more complex weighting function is possible just the same.

The time scaling can be realized for example in a dedicated processing block, that is, either in a delimited hardware circuit or a delimited software code. In particular in this case, the audio signal that is provided for time-scaling may be a decoded audio signal.

Alternatively, the time scaling could be realized for example in combination with another processing function, like a decoding or transcoding function. Combining a pitch-synchronous scaling technique with a speech decoder, for instance, is a particularly favorable approach to provide a high-quality time scaling capability. For example, with an AMR codec this provides clear benefits in terms of low processing load.

In particular, if the time scaling is integrated in a speech decoder, the audio signal that is provided for time-scaling may be a Linear Prediction (LP) synthesis filter excitation signal.

The audio signal provided for time-scaling may be for example an audio signal that is received via a packet switched network.

The invention can be applied to any type of audio codec, in particular, though not exclusively, to any type of speech codec. Further, it can be used for instance for AMR and VoIP.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 illustrates the principle of pitch synchronous time-scaling;

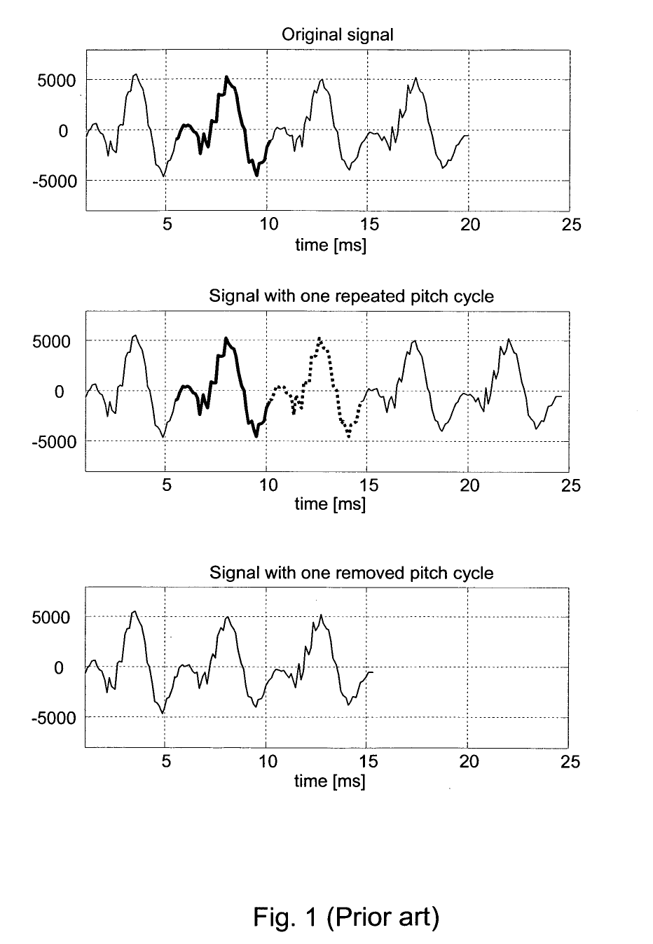

FIG. 2 is a diagram illustrating an insertion of a pitch cycle in a conventional pitch synchronous time-scaling;

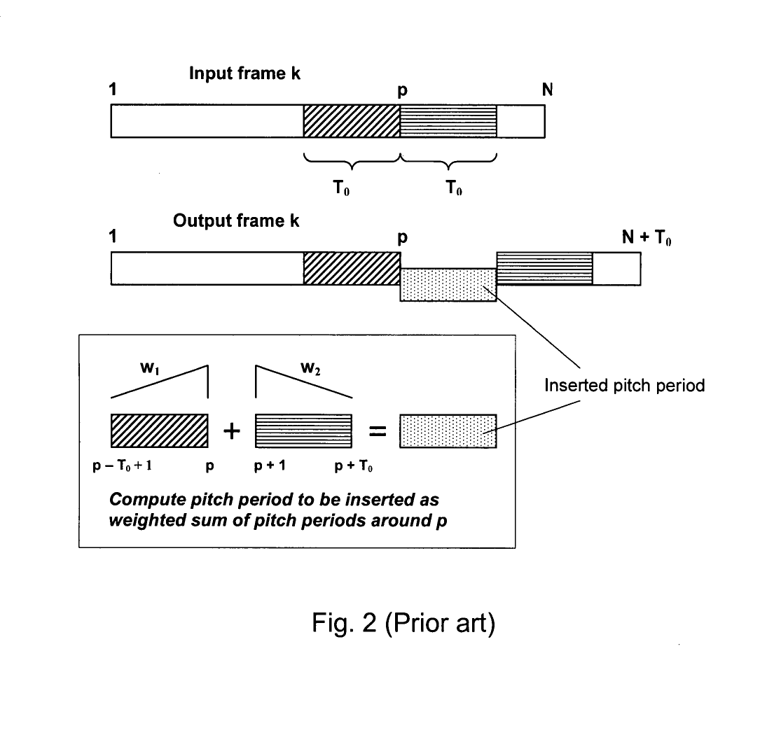

FIG. 3 is a diagram illustrating a removal of a pitch cycle in a conventional pitch synchronous time-scaling;

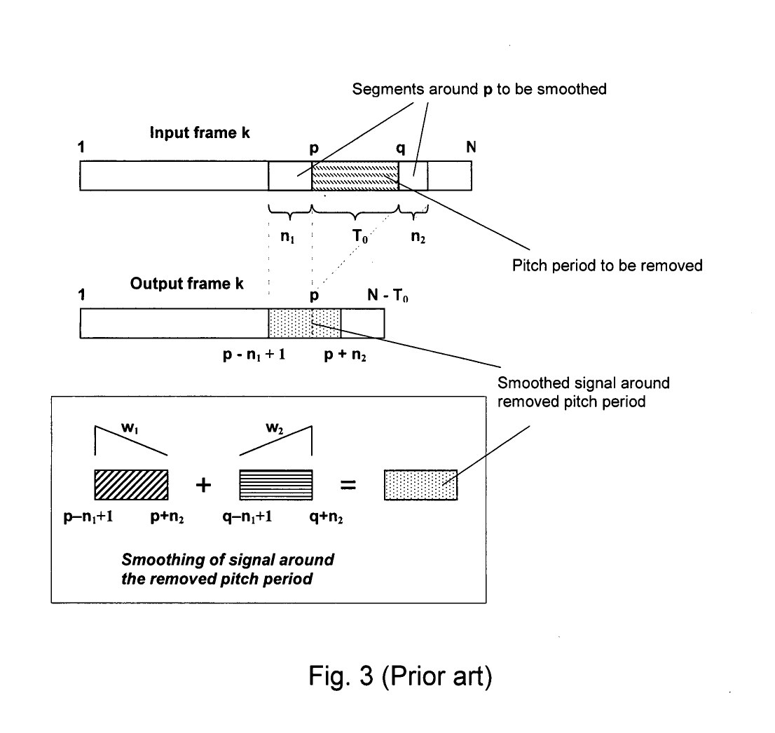

FIG. 4 is a diagram illustrating problems that may result with the pitch cycle removal of FIG. 3;

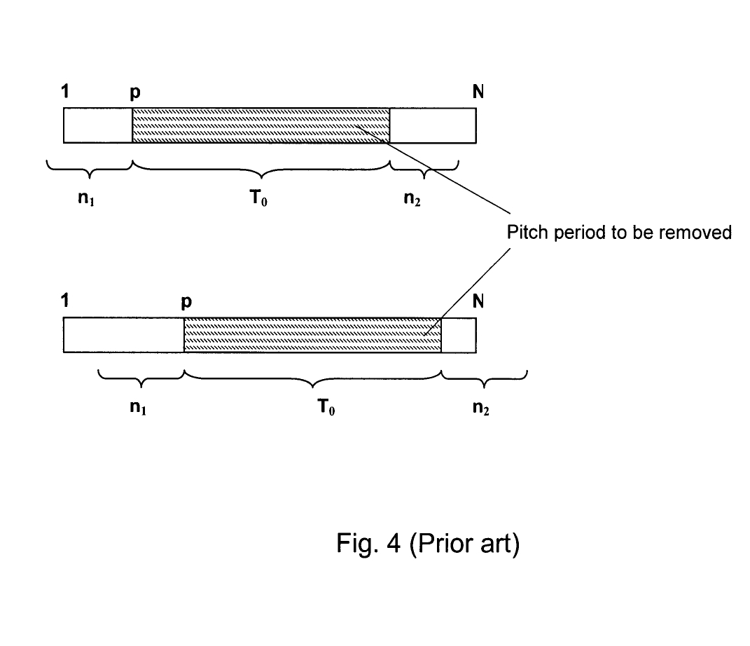

FIG. 5 is a schematic block diagram of a transmission system according to an embodiment of the invention;

FIG. 6 illustrates details of an audio receiver of the system of FIG. 5;

FIG. 7 is a flow chart illustrating an operation in the audio receiver of FIG. 6; and

FIG. 8 is a diagram illustrating a removal of a pitch cycle in the system of FIG. 5 in accordance with an embodiment of the invention.

### DETAILED DESCRIPTION OF THE INVENTION

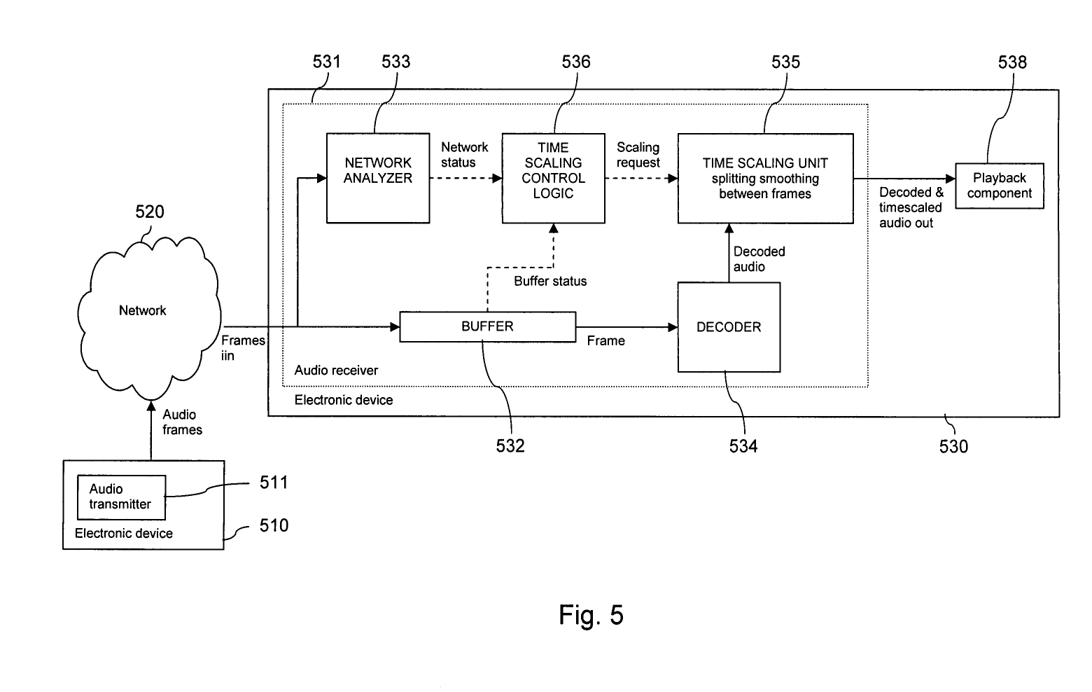

FIG. 5 is a schematic block diagram of an exemplary transmission system, in which an enhanced time-scaling according to an embodiment of the invention may be implemented.

The system comprises an electronic device 510 with an audio transmitter 511, a packet switched communication network 520 and an electronic device 530 with an audio receiver 531. The audio transmitter 511 may transmit audio frames including encoded audio data via the packet switched communication network 520 to the audio receiver 531, each packet comprising an audio frame with encoded audio data. It is to be understood that in an alternative approach, each packet could also comprise more than one audio frame.

The input of the audio receiver 531 is connected within the audio receiver 531 on the one hand to a jitter buffer 532 and on the other hand to a network analyzer 533. The jitter buffer 532 is connected via a decoder 534 and a time scaling unit 535 to the output of the audio receiver 531. A control signal output of the network analyzer 533 is connected to a first control input of a time scaling control logic 536, while a control signal output of the jitter buffer 532 is connected to a second control input of the time scaling control logic 536. A control signal output of the time scaling control logic 536 is further connected to a control input of the time scaling unit 535.

The output of the audio receiver 531 may be connected to a playback component 538 of the electronic device 530, for example to loudspeakers.

The jitter buffer 532 is used to store received audio frames waiting for decoding and playback. The jitter buffer 532 may have the capability to arrange received frames into the correct decoding order and to provide the arranged frames—or information about missing frames—in sequence to the decoder 534 upon request. In addition, the jitter buffer 532 provides information about its status to the time scaling control logic 536. The network analyzer 533 computes a set of parameters describing the current reception characteristics based on frame reception statistics and the timing of received frames and provides the set of parameters to the time scaling control logic 536. Based on the received information, the time scaling control logic 536 determines the need for a changing buffering delay and gives corresponding time scaling commands to the time scaling unit 535. The used average buffering delay does not have to be an integer multiple of the input frame length. The optimal average buffering delay is the one that minimizes the buffering time without any frames arriving late. The time scaling control logic 536 moreover gives corresponding time alignment commands to the time scaling unit 535.

The decoder 534 retrieves audio frames from the buffer 532 whenever new data is requested by the playback component 538. It decodes the retrieved audio frames and forwards the decoded audio frames to the time scaling unit 535. The time scaling unit 535 performs a scaling commanded by the time scaling control logic 536 in the next frame it receives for processing, but the exact point for scaling within a frame is chosen by a time scaling algorithm implemented in the time scaling unit 535. The time scaling unit 535 performs time scale modifications either by adding or by removing a segment or segments of an audio signal in accordance with the commands given by the time scaling control logic 536.

It is to be understood that the presented architecture of the audio receiver 531 of FIG. 5 is only intended to illustrate the basic logical functionality of an exemplary audio receiver according to the invention. In a practical implementation, the represented functions can be allocated differently to processing blocks. Some processing block of an alternative architecture may combine several ones of the functions described above. A time scaling unit combined with a decoder, for example, can provide a computationally very efficient solution.

Furthermore, there may be additional processing blocks, and some components, like the buffer 532, may even be arranged outside of the audio receiver 531.

The presented system may be implemented just like a conventional system in which audio data is transmitted from an audio transmitter to an audio receiver, except for the time scaling unit 535 of the audio receiver 531.

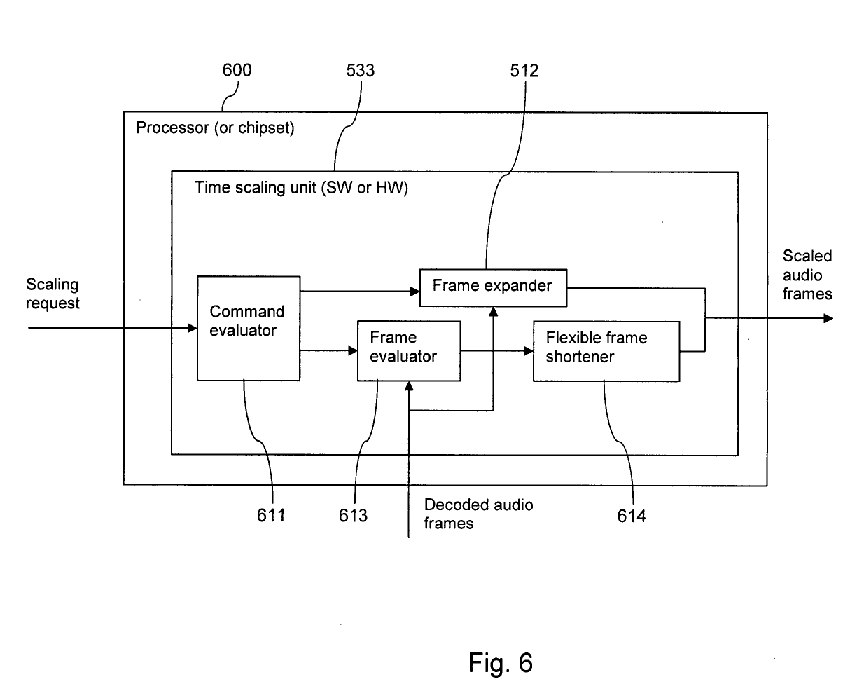

Functional details of this time scaling unit 535 are presented in FIG. 6.

The time scaling unit 535 may be implemented by a software code that can be executed by a processor 600 of the electronic device 531. It is to be understood that the same processor 600 could execute in addition software codes realizing other functions of the audio receiver 531 or, in general, of the electronic device 530. It has to be noted that, alternatively, the functions of the time scaling unit 535 could be realized by hardware, for instance by a circuit integrated in a chip or a chipset.

The time scaling unit 535 comprises a command evaluator component 611 receiving scaling commands from the time scaling control logic 536. The command evaluator component 611 is linked on the one hand to a frame expander component 612 and on the other hand via a frame evaluator component 613 to a variable frame shortener component 614. The decoded audio frames provided by the decoder 534 are fed to the frame evaluator component 613 and to the frame expander component 612. In addition, they are fed to the frame shortener component 614, either directly or via the frame evaluator component 613. The frame expander component 612 and the frame shortener component 614 provide the output of the time scaling unit 535.

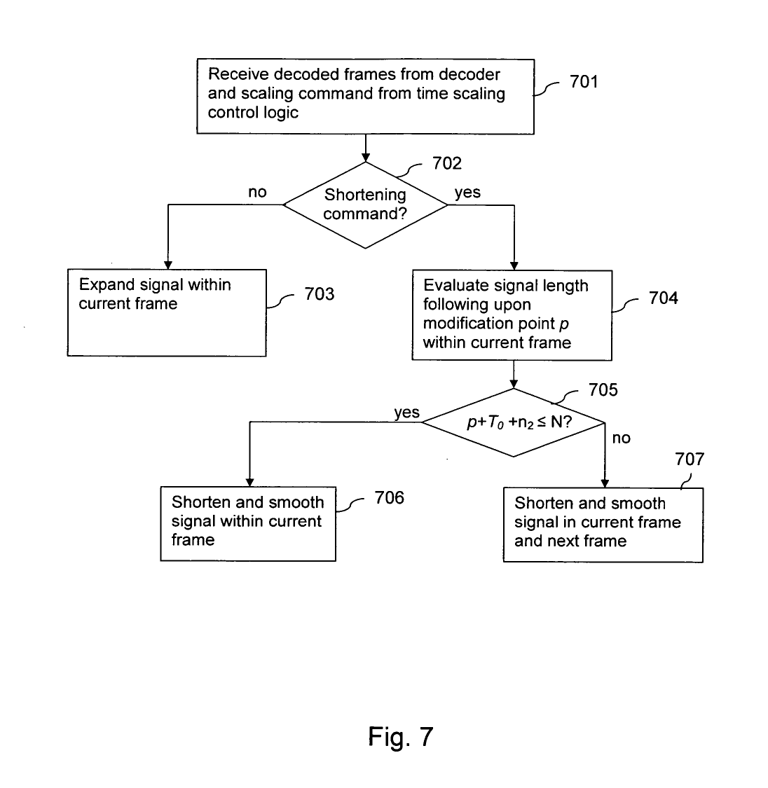

The operation of the time scaling unit 535 will now be described with reference to the flow chart of FIG. 7.

The time scaling unit 535 receives decoded audio frames from the decoder 534 and scaling commands from the time scaling control logic 536 (step 701).

The command evaluator component 611 determines whether a received scaling command requests a shortening or a lengthening of the audio signal and determines an optimal insertion or modification point p, respectively (step 702).

If the scaling command requests a lengthening of the audio signal, the frame expander component 612 is caused to process a received decoded frame. The frame expander component 612 lengthens and smoothes the audio signal within the current frame (step 703), for instance based on the above indicated set of equations (1).

If the scaling command requests a shortening of the audio signal, in contrast, the frame evaluator component 613 is caused to determine the number of samples following within the current frame after the determined modification point p (step 704).

If at least a complete pitch cycle plus a following smoothing section n₂ follow upon the modification point p within the current frame, this can be represented by p+T₀+n₂ N. The number of samples per input frame N is for example 160 in the case of AMR frames. T₀ is the pitch period and the length of the signal segment that is to be removed from the audio signal upon a shortening request. It may be determined constantly for the audio signal. The value of n₂ can be fixed or be determined for instance as a certain fraction of T₀.

If the frame evaluator component 613 determines that p+T₀+n₂ N (step 705), the frame shortener component 614 removes one pitch cycle from the audio signal within the current frame and performs a smoothing of the surrounding signal parts according to the above set of equations (2) (step 706).

If the frame evaluator component 613 determines that p+T₀+n₂>N (step 705), the frame shortener component 613 removes a pitch cycle and splits the smoothing of surrounding signal parts between the current frame and the next frame (step 707), as will be explained in the following.

For the current frame, new samples are generated according to the following set of equations:
sₒᵤₜ(k,i)=sᵢₙ(k,i), i=1 . . . p−n₁
sₒᵤₜ(k,i)=w₁(i−p+n₁)*sᵢₙ(k,i)+w₂(i−p+n₁)*sᵢₙ(k,i+T₀), i=p−n₁+1 . . . p+nₛ (3)
where sᵢₙ(k, i) denotes sample i of input frame k, sₒᵤₜ(k, i) denotes sample i of output frame k, N is the input frame length in samples, p is the selected modification point, T₀ is the pitch period in samples, w₁ and w₂ are weighting functions fulfilling w₁(i)+w₂(i)=1, and nₛ=N−T₀−p denotes the length of the signal following the removed pitch period as far as available in the current frame. Suitable weighting functions w₁ and w₂ could be for example again:
w₁(i)=1−i/(n₁+n₂)
w₂(i)=i/(n₁+n₂)

Furthermore, the rest of the smoothing is applied at the beginning of the next frame according to the equation, forming now the current frame:
sₒᵤₜ(k+1,i)=w₁(i+nₛ+n₁)*sᵢₙ(k,p+nₛ+i)+w₂(i+nₛ+n₁)*sᵢₙ(k+1,i), i=1 . . . n₂−nₛ (4)

The parameters in this equation have the same meaning as the corresponding parameters in the set of equations (3), except that sᵢₙ(k+1, i) denotes sample i of new input frame k+1, and sₒᵤₜ(k+1, i) denotes sample i of new output frame k+1.

The rest of the samples n₂−nₛ through N of output frame k+1 may correspond to the samples n₂−nₛ through N of input frame k+1.

Thus, even if the actual shortening of the signal already took place in frame k, the smoothing process is completed by adjusting the values of n₂−nₛ first samples of frame k+1, as specified in equation (4).

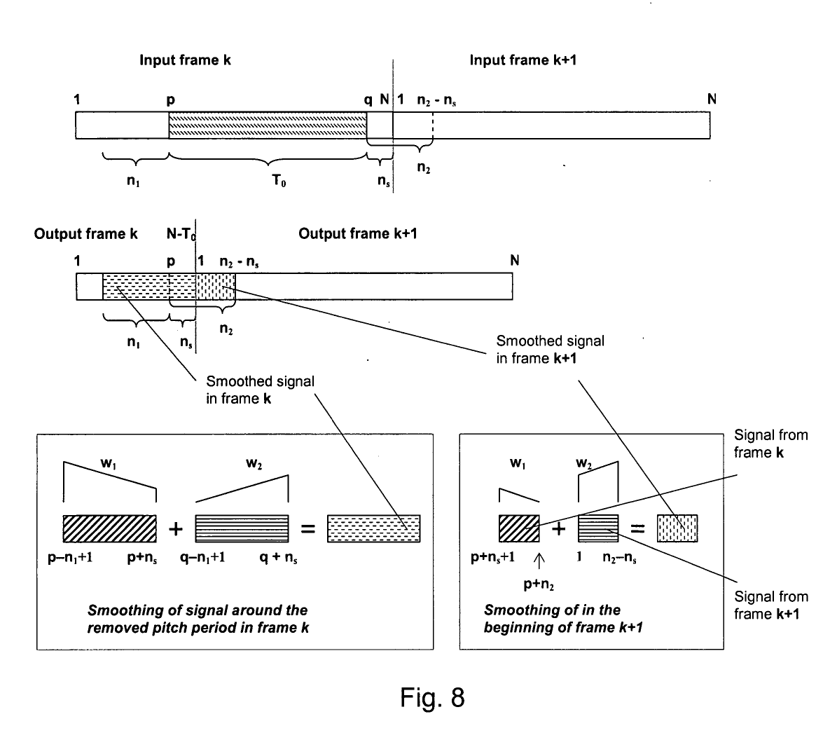

The smoothing according to equations (3) and (4) is also illustrated in FIG. 8.

FIG. 8 presents an input frame k of length N, and a subsequent input frame k+1 of length N. For input frame k, a number of samples n₁ preceding a selected modification point p, a pitch period T₀ following upon modification point p up to point q=p+T₀, and a number of samples nₛ further following upon this point q are indicated. For input frame k+1, the first n₂−nₛ samples are indicated.

FIG. 8 further presents a generated output frame k of length N−T₀ and a generated subsequent output frame k+1 of length N. In output frame k, T₀ samples of input frame k following modification point p have been removed. The n₁ samples preceding modification point p and the nₛ samples succeeding modification point p in the output frame k have been smoothed according to equation (3). The first n₂−nₛ samples of output frame k+1 have been smoothed according to equation (4). The smoothing of the audio signal in output frame k is based exclusively on samples from input frame k. The smoothing of the audio signal in output frame k+1 is based on samples from both input frame k and input frame k+1.

It has to be noted that although the presented equations use a simple triangular weighting window for smoothing the signal around the modification point, also other kinds of weighting functions could be used.

If the time scaling unit 535 is operating as a separate processing block as illustrated, the described time scale modification is usually performed on the decoded speech signal. If the time scaling unit 535 is combined with the decoder 534, the described time scale modification can be performed for instance on the LP synthesis filter excitation signal generated in the decoder 534.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for time-scaling an audio signal, said audio signal being distributed to a sequence of frames, wherein in case said audio signal is to be shortened in said time-scaling, said method comprises:
removing one scaling period from said audio signal within a current frame; and
modifying a segment of said audio signal following upon said removed scaling period for concealing said removal of a scaling period at least partly in a subsequent frame, in case a segment of said audio signal following upon said removed scaling period within said current frame is shorter than desired for said modification.

2. The method according to claim 1, wherein said scaling period is a pitch period in said audio signal.

3. The method according to claim 1, wherein said modification uses a weighting function.

4. The method according to claim 3, wherein said weighting function is a triangular weighting function.

5. The method according to claim 1, wherein said current frame is an input frame k that is time-scaled according to the following set of equations to obtain an output frame k:
sₒᵤₜ(k,i)=sᵢₙ(k,i) with i=1 . . . p−n₁
sₒᵤₜ(k,i)=w₁(i−p+n₁)*sᵢₙ(k,i)+w₂(i−p+n₁)*sᵢₙ(k,i+T₀) with i=p−n₁+1 . . . p+nₛ
where sᵢₙ(k, i) denotes sample i of an input frame k, sₒᵤₜ(k, i) denotes sample i of an output frame k, N is an input frame length in samples, p is a selected modification point, T₀ is a scaling period in samples, w₁ and w₂ are weighting functions, n₁ is a number of samples preceding said removed scaling period that are to be modified, n₂ is a number of samples following said removed scaling period that are to be modified, and nₛ=N−T₀−p.

6. The method according to claim 5, wherein said subsequent frame is an input frame k+1, in which first samples are modified according to the following equation to obtain an output frame k+1:
sₒᵤₜ(k+1,i)=w₁(i+nₛ+n₁)*sᵢₙ(k,p+nₛ+i)+w₂(i+nₛ+n₁)*sᵢₙ(k+1, i) with i=1 . . . n₂−nₛ
where sᵢₙ(k+1, i) denotes sample i of an input frame k+1 and sₒᵤₜ(k+1, i) denotes sample i of an output frame k+1.

7. The method according to claim 1, wherein said audio signal is a decoded audio signal.

8. The method according to claim 1, wherein said audio signal is a linear prediction synthesis filter excitation signal.

9. The method according to claim 1, wherein said audio signal is received via a packet switched network.

10. A chipset with at least one chip for time-scaling an audio signal, said audio signal being distributed to a sequence of frames, said at least one chip comprising a frame shortening component,
said frame shortening component being adapted to remove one scaling period from an audio signal within a current frame, in case said audio signal is to be shortened in said time-scaling; and
said frame shortening component being adapted to modify a segment of an audio signal following upon a removed scaling period, for concealing said removal of a scaling period, at least partly in a subsequent frame, in case a segment of said audio signal following upon said removed scaling period within said current frame is shorter than desired for said modification.

11. An audio receiver comprising a time scaling unit for time-scaling an audio signal, said audio signal being distributed to a sequence of frames, said time scaling unit comprising a frame shortening component,
said frame shortening component being adapted to remove one scaling period from an audio signal within a current frame, in case said audio signal is to be shortened in said time-scaling; and
said frame shortening component being adapted to modify a segment of an audio signal following upon a removed scaling period, for concealing said removal of a scaling period, at least partly in a subsequent frame, in case a segment of said audio signal following upon said removed scaling period within said current frame is shorter than desired for said modification.

12. An electronic device comprising a time scaling unit for time-scaling an audio signal, said audio signal being distributed to a sequence of frames, said time scaling unit comprising a frame shortening component,
said frame shortening component being adapted to remove one scaling period from an audio signal within a current frame, in case said audio signal is to be shortened in said time-scaling; and
said frame shortening component being adapted to modify a segment of an audio signal following upon a removed scaling period, for concealing said removal of a scaling period, at least partly in a subsequent frame, in case a segment of said audio signal following upon said removed scaling period within said current frame is shorter than desired for said modification.

13. The electronic device according to claim 12, wherein said scaling period is a pitch period in said audio signal.

14. The electronic device according to claim 12, further comprising a decoder, which is adapted to provide a decoded audio signal as said audio signal to said time scaling unit.

15. The electronic device according to claim 14, wherein said decoder is an Adaptive MultiRate decoder.

16. The electronic device according to claim 12, further comprising a decoder, which is adapted to provide a linear prediction synthesis filter excitation signal as said audio signal to said time scaling unit.

17. A system comprising a transmission network adapted to transmit audio signals, a transmitter adapted to provide audio signals for transmission via said transmission network and a receiver adapted to receive audio signals via said transmission network, said receiver including a time scaling unit for time-scaling an audio signal, said audio signal being distributed to a sequence of frames, said time scaling unit comprising a frame shortening component,
said frame shortening component being adapted to remove one scaling period from an audio signal within a current frame, in case said audio signal is to be shortened in said time-scaling; and
said frame shortening component being adapted to modify a segment of an audio signal following upon a removed scaling period, for concealing said removal of a scaling period, at least partly in a subsequent frame, in case a segment of said audio signal following upon said removed scaling period within said current frame is shorter than desired for said modification.

18. The system according to claim 17, wherein said transmission network is a packet switched network.

19. A software program product in which a software code for time-scaling an audio signal is stored in a readable medium, said audio signal being distributed to a sequence of frames, wherein in case said audio signal is to be shortened in said time-scaling, said software code realizes the following steps when being executed by a processor:
removing one scaling period from said audio signal within a current frame; and
modifying a segment of said audio signal following upon said removed scaling period, for concealing said removal of a scaling period, at least partly in a subsequent frame, in case a segment of said audio signal following upon said removed scaling period within said current frame is shorter than desired for said modification.

20. The software program product according to claim 19, wherein said current frame is an input frame k that is time-scaled according to the following set of equations to obtain an output frame k:
sₒᵤₜ(k,i)=sᵢₙ(k,i) with i=1 . . . p−n₁
sₒᵤₜ(k,i)=w₁(i−p+n₁)*sᵢₙ(k,i)+w₂(i−p+n₁)*sᵢₙ(k, i+T₀) with i=p−n₁+1 . . . p+nₛ
where sᵢₙ(k, i) denotes sample i of an input frame k, sₒᵤₜ(k, i) denotes sample i of an output frame k, N is an input frame length in samples, p is a selected modification point, T₀ is a scaling period in samples, w₁ and w₂ are weighting functions, n₁ is a number of samples preceding said removed scaling period that are to be modified, n₂ is a number of samples following said removed scaling period that are to be modified, and nₛ=N−T₀−p.

21. The software program product according to claim 20, wherein said subsequent frame is an input frame k+1, in which first samples are modified according to the following equation to obtain an output frame k+1:
sₒᵤₜ(k+1,i)=w₁(i+nₛ+n₁)*sᵢₙ(k,p+nₛ+i)+w₂(i+nₛ+n₁)*sᵢₙ(k+1, i) with i=1 . . . n₂−nₛ
where sᵢₙ(k+1, i) denotes sample i of an input frame k+1 and sₒᵤₜ(k+1, i) denotes sample i of an output frame k+1.
